(19) United States
(12) Patent Application Publication
(10) Pub. No.: US 2008/0048994 A1
(43) Pub. Date: Feb. 28, 2008

(54) Liquid crystal display device having touch panel function and method for detecting a touch position

(75) Inventors: Joo-Hyung Lee, Gyeonggi-do (KR); Kee-Han Uh, Gyeonggi-do (KR); Young-Ok Cha, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/895,433

(22) Filed: Aug. 24, 2007

(30) Foreign Application Priority Data
Aug. 25, 2006 (KR) 10-2006-0080845

(51) Int. Cl. G06F 3/041

(52) U.S. Cl. 345/173

(57) ABSTRACT

A liquid crystal display (LCD) device includes a first substrate, a second substrate spaced apart from the first substrate and a liquid crystal layer interposed between the substrates. A sensing controlling section is also included in the LCD device. The second substrate includes a sensing array that senses a change in a sensing voltage responsive to a change in a thickness of the liquid crystal layer. The sensing controlling section detects a touch position data by comparing a reference voltage that changes according to a change in temperature with a variation voltage that corresponds to a difference between the sensing voltage and an initial voltage corresponding to an initial thickness of the untouched liquid crystal layer.

### CROSS-REFERENCE TO RELATED APPLICATIONS

This application claims priority under 35 U.S.C. § 119 to Korean Patent Application No. 10-2006-80845 filed on Aug. 25, 2006 in the Korean Intellectual Property Office (KIPO), the contents of which are herein incorporated by reference in its entirety.

### BACKGROUND OF THE INVENTION

1. Field of the Invention

The present invention relates to a liquid crystal display (LCD) device having a touch panel function and a method for detecting a touch location in the LCD device. More particularly, the present invention relates to an LCD device having a touch panel function, which is capable of enhancing a touch location detecting capability and a method for detecting a touch location in the LCD device.

2. Description of the Related Art

Generally, a touch panel is on an uppermost portion of an LCD device to enable contact with a finger or a touching object, such as a stylus, so that the user selects information displayed on the screen of the LCD device. The touch panel detects a touch location at which the finger or the touching object makes contact with the screen, and changes the sensed contact into an input signal to be applied by the LCD device. The touch panel includes a first substrate, a second substrate that is spaced apart from the first substrate by a predetermined distance, a first transparent electrode that is formed on the first substrate, and a second transparent electrode that is formed on the second substrate, where the respective electroded surfaces face each other, and a liquid crystal layer is interposed between the two substrates.

When a computer includes the LCD device having the touch panel, an additional input apparatus such as a keyboard, a mouse, etc., may not be necessary. Thus, the touch panel may be widely used.

When the touch panel is formed on an LCD panel of the LCD device, thickness and size of the LCD device having the touch panel may be increased. In order to decrease the thickness and size of the LCD device, the touch panel may be integrally formed with the LCD device. For example, the LCD device may include a photo sensor that detects a shadow formed by the finger or the touching object blocking the light when touching the touch panel, or the photo sensor may detect additional light generated from a light pen touching the touch panel.

However, in LCD panels having an integrally-formed touch panel, a low signal-to-noise ratio (SNR) may occur, with the result that stability of operation of the LCD device may be decreased, and yield of the LCD device may also be decreased.

### SUMMARY OF THE INVENTION

The present invention provides an LCD device capable of enhancing the detecting capability of touch location sensing.

The present invention provides a method of enhanced detecting of touch position sensitivity in relative to a noise component of sensing and temperature effects in an LCD panel.

In one aspect of the present disclosure, an LCD device includes a first substrate, a second substrate, a liquid crystal layer interposed therebetween, and a sensing controlling section. The second substrate includes a sensing array that senses a voltage change in accordance with a change in thickness of the liquid crystal layer. The sensing controlling section detects a touch location signal by comparing a reference voltage—that changes according to temperature—with a voltage change that corresponds to a difference between the sensed voltage and an initial reference voltage corresponding to an initial reference thickness of the liquid crystal layer.

In another aspect of the present invention, there is provided a method of detecting a touch location signal of an LCD panel having an array substrate, an opposing substrate, and a liquid crystal layer interposed between the array and opposing substrates. According to the above method, a sensing voltage changing in accordance with a changing thickness of the liquid crystal layer induced by compression of external sides of either or both substrates is detected. The sensing voltage and an initial reference voltage corresponding to an initial thickness of the liquid crystal layer are compared to extract the voltage shift. The voltage shift and a reference voltage—that may vary according to temperature—are compared to determine whether the LCD panel is touched or not. A touch position location signal is detected by using the sensing voltage when the LCD panel is touched.

According to the LCD device and the method for detecting a touch position in the LCD device, the reference voltage may vary according to temperature, so that, by eliminating the voltage offset introduced by temperature change, a similar signal-to-noise ratio (SNR) is ensured for determining whether or not the LCD panel is touched, independent of temperature, whereby detecting the touch position location signal may be enhanced.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view illustrating a liquid crystal display (LCD) device according to an exemplary embodiment of the present invention;

FIG. 2 is a cross-sectional view of a portion of the LCD panel in FIG. 1;

FIG. 3 is a circuit diagram of a sensing circuit for the array in FIG. 1; and

FIG. 4 is a flow chart showing a method of detecting a touch position according to an exemplary embodiment of the present invention.

### DESCRIPTION OF THE EMBODIMENTS

Embodiments of the present invention are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,”, when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

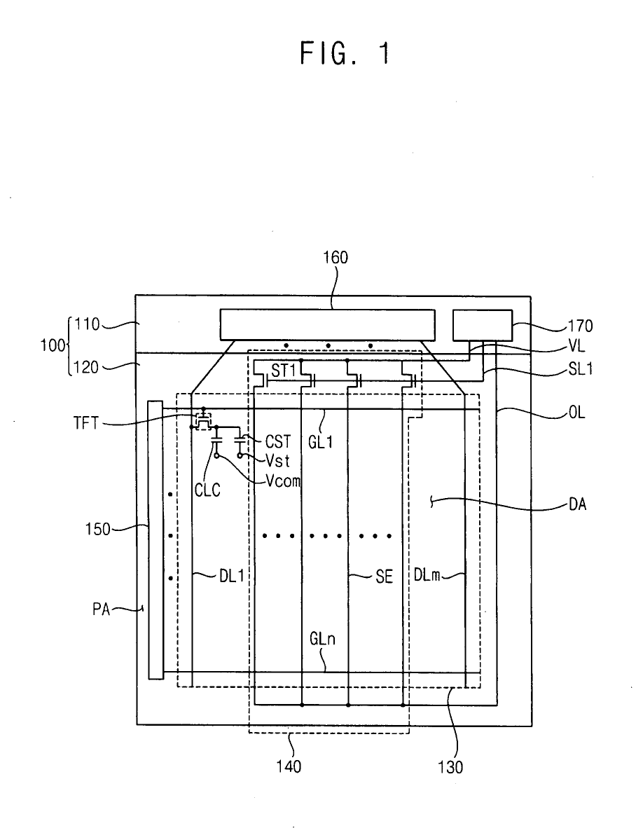

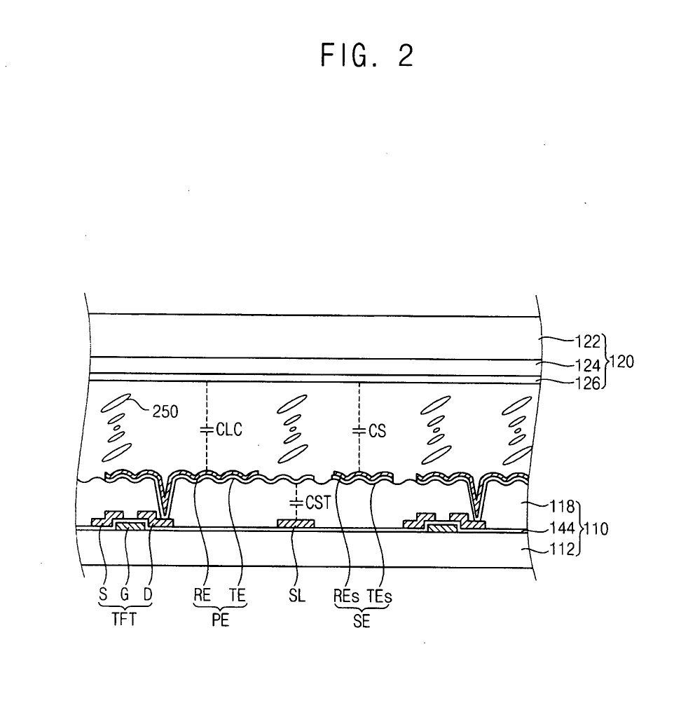

FIG. 1 is a plan view illustrating a liquid crystal display (LCD) device according to an exemplary embodiment of the present invention. FIG. 2 is a cross-sectional view of a portion of the LCD panel in FIG. 1.

Referring to FIGS. 1 and 2, an LCD device according to an exemplary embodiment of the present invention includes an LCD panel 100 that has an array substrate 110, an opposite substrate (i.e. a color filter substrate) 120 and a liquid crystal layer 250 interposed between the array substrate 110 and the opposite substrate 120.

The array substrate 110 includes a display area DA and a peripheral area PA that surrounds the display area DA. A pixel array 130 and a sensing array 140 are formed in the display area DA.

The pixel array 130 is formed corresponding to the display area DA in a matrix shape. The pixel array 130 includes a plurality of gate lines GL1 through GLn, a plurality of data lines DL1 through DLm, a plurality of thin-film transistors TFTs and a plurality of pixel electrodes PEs. Here, ‘n’ and ‘m’ represent integer numbers, respectively.

The gate lines GL1 through GLn extend in a first direction, and the data lines DL1 through DLm extend in a second direction different from the first direction, across the gate lines GL1 through GLn. The pixel sections of a matrix shape are defined by the gate lines GL1 through GLn and the data lines DL1 through DLm. The thin-film transistor TFT, which is electrically connected to the gate line GL and the data line DL, is formed in the pixel sections. Each of the pixel electrodes PE includes a transparent electrode TE and a reflection electrode RE. Each of the pixel electrodes PE is formed in each of the pixel sections, respectively.

The sensing array 140 includes a sensing electrode SE and a sensing switching element ST1. The sensing electrode SE extends in a direction parallel with a plurality of data lines DL1 through DLm in correspondence with the display area DA.

For example, the sensing electrode SE includes a sensing transmittance electrode TEs and a sensing reflection electrode REs. The sensing transmittance electrode TEs and a plurality of pixel electrodes PE are formed on an organic insulation layer 118. The sensing electrode SE is simultaneously patterned with a transmittance electrode TE. The sensing reflection electrode REs is disposed on the sensing transmittance electrode TEs, and is simultaneously patterned with the reflection electrode RE. In FIG. 2, ‘112’ represents a first substrate, ‘114’ represents a gate insulation layer, and ‘116’ represents a data line DL.

The sensing switching element ST1 is formed into the peripheral area PA of the array substrate 110. That is, the sensing switching element ST1 is formed on the peripheral area PA of the array substrate 110 adjacent to a first end portion of the data lines DL1 through DLm.

The sensing array 140 may further include a driving voltage line VL, a switching line SL1 and an output line OL that are arranged in the peripheral area PA. A gate electrode of the sensing switching element ST1 is electrically connected to the sensing switching line SL1, a drain electrode of ST1 is electrically connected to the driving voltage line VL, and a source electrode of ST1 is electrically connected to a first end portion of the sensing electrode SE. A second end portion of the sensing electrode SE is electrically connected to the output line OL.

As shown in FIG. 2, the color filter substrate 120, which faces the array substrate 110, includes a second transparent substrate 122, a plurality of color patterns 124 and a common electrode 126 formed thereon. The color patterns 124 may include a red color pattern, a green color pattern and a blue color pattern. The color patterns 124 may display a composite color. The common electrode 126 may include an optically transparent and electrically conductive material.

Here, the common electrode 126, the pixel electrode PE and the sensing electrode SE define, respectively, a liquid crystal capacitor CLC and a sensing capacitor CS. The pixel electrode PE is spaced apart from the sensing electrode SE by interposing the common electrode 126 and the liquid crystal layer 250 therebetween. That is, the common electrode 126 is opposite to the transmittance electrode TE by interposing the liquid crystal layer 250 therebetween, so that a liquid crystal capacitor CLC is defined. The common electrode 126 is opposite to the sensing electrode SE by interposing the liquid crystal layer 250 therebetween, so that a sensing capacitor CS is defined. Additionally, the transmittance electrode TE is opposite to a storage line SL by interposing the organic insulation layer 118 therebetween, so that a storage capacitor CST may be defined. In FIG. 2, the TFT may include a gate electrode G extended from the gate line GL, a source electrode S extended from the data line DL and a drain electrode D spaced apart from the source electrode S. Here, the storage line SL, the source electrode S and the drain electrode D are formed from a same layer.

The LCD device includes driving circuits for driving the pixel array 130, and a sensing control part 170 for controlling the sensing array 140. The driving circuits include a gate drive circuit 150 and a data drive circuit 160.

The gate drive circuit 150 is electrically connected to a first end portion of the gate lines GL1 through GLn to sequentially provide the gate lines GL1 through GLn with gate signals. The gate drive circuit 150 is formed on the array substrate 110 when the pixel array 130 is formed through a thin-film process.

The data drive circuit 160 is electrically connected to a first end portion of the data lines DL1 through DLm to provide the data lines DL1 through DLm with data signals. The data drive circuit 160 is built into a chip. The chip built into the data drive circuit 160 is mounted on the peripheral area PA of the array substrate 110.

The sensing control part 170 provides the sensing array 140 with a driving voltage VDD via line VL, and a sensing switching signal SS via line SL1, and then receives a voltage output OL from node N1 of the sensing array 140, so that the sensing control part 170 determines whether the LCD panel 100 is touched or not. Then, the sensing control part 170 generates a touch position data and outputs the touch position data to an external device (not shown). That is, the sensing control part 170 provides the driving voltage line VL with a driving voltage VDD and provides the sensing switching element ST1 with the sensing switching signal SS to drive the sensing array 140. Sensing control part 170 may further have temperature sensing capability to determine the temperature of the LCD panel. The sensing control part 170 and the data driving circuit 160 may be built into a chip.

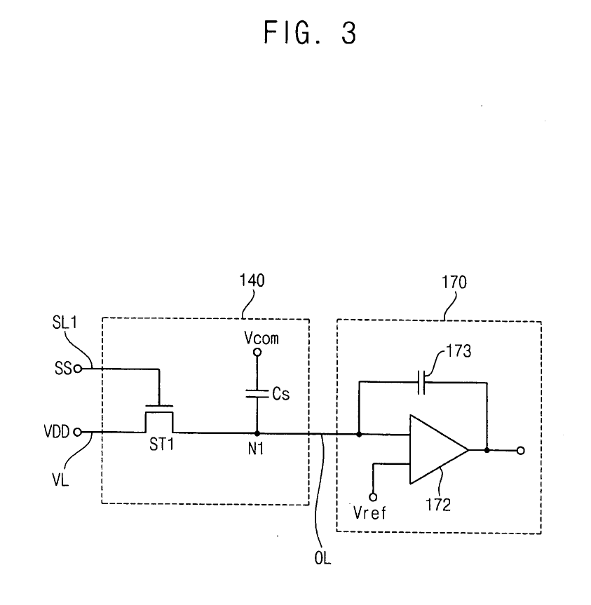

FIG. 3 is a circuit diagram schematically illustrating a portion of the sensing array 140 and a portion of sensing part 170 of the sensing array in FIG. 1.

Referring to FIG. 3, a sensing array 140 outputs an initial sensed voltage before the LCD panel 100 is touched. However, sensing array 140 outputs a later sensed voltage when the LCD panel 100 is touched, (hereinafter, referred to as a later sensed voltage) that is lower than the initial sensed voltage. The sensing voltage that is output from the sensing array 140 over line OL is amplified to about the level of a reference voltage Vref through an operational amplifier (OP-Amp) 172. Here, the reference voltage Vref may be established as a voltage corresponding to when the user does not touch the LCD panel 100.

FIG. 3, ‘173’ represents a capacitor electrically connected to a first input terminal of the operational amplifier (OP-Amp) 172 and an output terminal 170-1 of the OP-Amp 172. The OP-Amp 172 may be included as part of the sensing control 170, which amplifies the sensing voltage output from the sensing array 140.

Typically, the sensing switching element ST1 is turned-on in response to the sensing switching signal SS and the driving voltage VDD, before the LCD panel 100 is touched by user. Then, when the common voltage Vcom is applied to the common electrode 126, a voltage of the first node N1 (i.e. the sensing electrode) is gradually increased to the initial voltage by the sensing capacitor CS. Here, one of the switching signal SS and the common voltage Vcom may be an-alternating voltage, or one of the driving voltage VDD and the common voltage Vcom may be an alternating voltage.

When the user touches the LCD panel 100, the thickness of the liquid crystal layer 250 is varied, so that value of sensing capacitor CS changes as the thickness of the liquid crystal layer changes. Therefore, touching the display panel may cause the voltage of the first node N1 to vary in response to the touch. That is, as the thickness of the liquid crystal layer 250 decreases by touching, a voltage level of the first node N1 shifts to a voltage having relatively lower magnitude than the initial reference voltage.

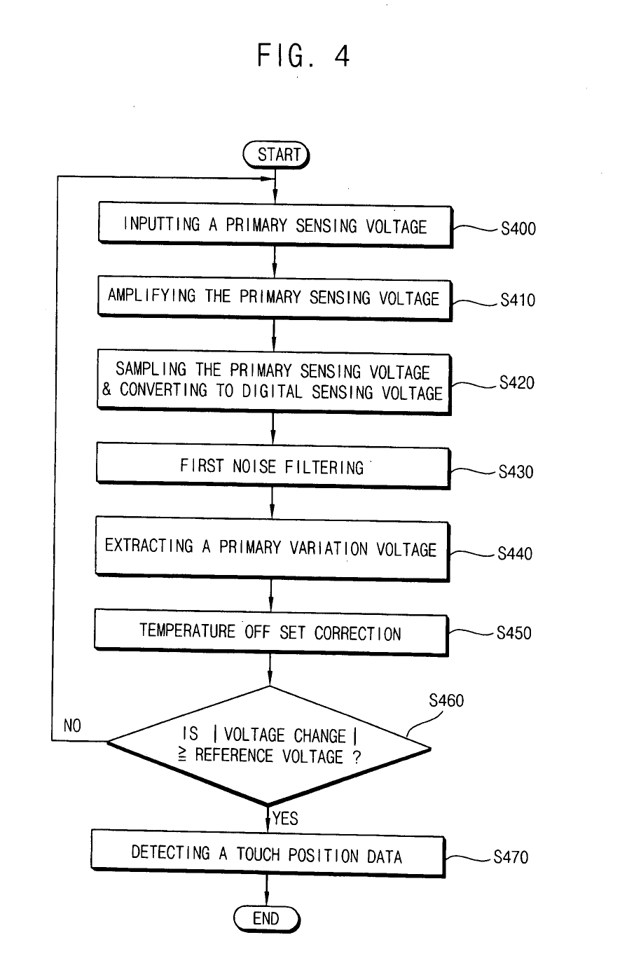

FIG. 4 is a flow chart showing a method of detecting a touch position according to an exemplary embodiment of the present invention.

Referring to FIGS. 1 to 4, a method of detecting a touch position according to an exemplary embodiment of the present invention is described.

A primary sensing voltage is input to the sensing control section 170, which is detected by the sensing array 170 based on the sensing switching signal SS and the driving voltage VDD (step S400). The primary sensing voltage is an analog signal. Then, the primary sensing voltage is amplified through the OP-amp 172 about a reference voltage Vref (step S410).

Then, the amplified sensing voltage about the reference voltage Vref, is sampled to be converted to a digital sensing voltage (step S420). That is, the primary sensing voltage is sampled, and then the sampled primary sensing voltage is converted to the digital sensing voltage through an analog-digital converter (ADC).

The digital sensing voltage may include a noise signal, so that a first noise filtering is performed to remove the noise signal (step S430). In the first noise filtering, a bit error or a noise component that has high frequency content, is smoothed, so that a signal-to-noise ratio (SNR) is enhanced.

Then, the digital sensing voltage that is first noise filtered is compared with a reference voltage, so that a primary variation voltage is extracted (step S440). That is, a sensing switching signal SS and a driving voltage VDD are provided to the sensing array 170, and the reference voltage corresponding to when the user does not touch the LCD panel 100 is compared with the sensing voltage, so that a changing signal occurs when the user touches the LCD panel 100. Thus, a voltage change of the sensor electrode SE due to touch is extracted.

An offset component of voltage is removed from the extracted primary variation voltage through an offset correction due to temperature effects, and then a variation voltage having an enhanced SNR is measured (step S450).

The variation voltage according to the temperature offset correction is compared with a reference voltage Vth, which is defined below, that depends on temperature, and then it is determined whether the LCD panel 100 is touched or not by the user (step S460). That is, when the voltage change is relatively small compared to the reference voltage Vth, it is determined that the LCD panel 100 is not touched so that the above-mentioned steps are repeated. When the voltage change is relatively comparable to the reference voltage Vth, it is determined that the LCD panel 100 is touched so that a touch position data is extracted using the sensed voltage (step S470).

Here, the reference voltage Vth is determined by a primary fixed component and a temperature dependant component according to the following equation 1, which is the reference voltage determining whether the LCD panel 100 is touched or not by comparing it with the variation voltage.

Equation 1

Vth=d+(c×x)

wherein, ‘d’ denotes a primary reference voltage of the LCD panel 100 when not touched, and at a reference temperature, ‘x’ denotes a temperature difference relative to a reference temperature, and ‘c’ denotes a ratio of voltage variation with temperature. Here, ‘c’ is not zero, and ‘c’ and ‘d’ are fixed values.

That is, the reference voltage Vth may be defined by the sum total of a primary fixed component of the LCD panel 100 and a component that is variable (increased or decreased) in accordance with temperature. Here, the temperature that determines a shift of the variable component of the reference voltage may be the temperature of the LCD panel 100.

For example, a signal (i.e. the voltage change when the panel is touched) and a temperature variable component are increased when the temperature of the LCD panel 100 is high relative to a reference temperature, and the signal and the temperature variable component are decreased when the temperature of the LCD 100 is low relative to a reference temperature. Thus, the reference voltage Vth may be higher than a detected component of a signal at a higher temperature, and may be lower than that of a detected signal at a lower temperature. Therefore, a component of the reference voltage may vary with temperature.

According to the present invention, in the method for detecting a touch position in the LCD panel according to the present invention, the reference voltage Vth that is referenced to determine whether the LCD panel 100 is touched or not includes a temperature dependence so that a stable operation of the LCD panel may be ensured independent of change in temperature. In the embodiments which include a Vth dependence on temperature as in Equation 1, the change in Vth is linearly dependent on temperature. Other forms of Equation 1, in which the dependence on temperature is more complex, may be in accordance with the scope of the disclosure. In addition, even though variations may occur in the LCD panel due to process variations, a similar signal-to-noise ratio (SNR), i.e., a similar sensed voltage change signal ratio to reference voltage Vth is maintained so that a stability of an operation of the LCD device may be ensured. Furthermore, a yield of the LCD device may be increased to enhance a detecting capability of a touch position under conditions of variable temperature.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A liquid crystal display (LCD) device comprising:
a first substrate;
a second substrate supported in spaced apart relationship with the first substrate;
a liquid crystal layer interposed between the first substrate and the second substrate, wherein the second substrate comprises a sensing array adapted to sense a voltage change in accordance with a change in a thickness of the liquid crystal layer responsive to a touch of the LCD; and
a sensing controlling section adapted to identify a location of a position touched by comparing an initial reference voltage corresponding to an initial thickness of the liquid crystal layer when the LCD is not touched, wherein the initial reference voltage changes as a function of temperature with a difference voltage that corresponds to a difference between the sensing voltage and the initial reference voltage.

2. The LCD device of claim 1, wherein the sensing array comprises:
a plurality of sensing electrodes formed in a display area of the second substrate; and
a plurality of sensing switching elements formed in a peripheral area of the second substrate, each sensing switching element being electrically connected to an associated one of the sensing electrodes.

3. The LCD device of claim 1, wherein the sensing controlling section is adapted to provide the sensing array with a driving voltage and a sensing switching signal, and to determine whether the LCD panel defined by the first and second substrates and the liquid crystal layer is touched or not, based on a voltage output from the sensing array.

4. The LCD device of claim 3, wherein the reference voltage (Vth) is defined by Vth=d+(c×x),
wherein, ‘d’ denotes an initial reference voltage value of the LCD panel 100 when not touched, and at a reference temperature, ‘x’ denotes a temperature difference relative to the reference temperature, and ‘c’ denotes a ratio of the reference voltage variation with temperature variation.

5. The LCD device of claim 3, wherein the temperature is a temperature of the LCD panel.

6. A method of detecting a touch position of a liquid crystal display (LCD) panel having an array substrate, an opposing substrate, and a liquid crystal layer interposed between the array and opposing substrates, the method comprising:
detecting a sensing voltage changing in accordance with a thickness variation of the liquid crystal layer, which is induced by compression of external sides of the array substrate and opposing substrate when the LCD panel is touched;
comparing the sensing voltage with an initial reference voltage corresponding to an initial thickness of the liquid crystal layer to extract a change in voltage;
comparing an initial reference voltage when the LCD panel is not touched, and that changes according to temperature change, with the sensed change in voltage to determine whether the LCD panel is touched or not; and
detecting a touch position location by using the sensing voltage when the LCD panel is touched.

7. The method of claim 6, wherein the reference voltage (Vth) is defined by Vth=d+(c×x),
wherein, ‘d’ denotes a primary reference voltage value of the LCD panel 100 when not touched, and at a reference temperature, ‘x’ denotes a temperature difference relative to a reference temperature, and ‘c’ denotes a ratio of the reference voltage variation with temperature variation.

8. The method of claim 7, wherein the temperature is a temperature of the LCD panel.

9. The method of claim 6, wherein detecting the sensing voltage comprises:
measuring an initial reference sensing voltage of an analog type corresponding to the thickness of the liquid crystal layer when the LCD panel is untouched;
amplifying the initial reference sensing voltage to substantially equal a reference voltage; and
sampling the amplified reference sensing voltage to convert the amplified reference sensing voltage into a reference sensing voltage signal of a digital type.

10. The method of claim 9, wherein extracting the change in voltage in accordance with a variation of the liquid crystal layer comprises:
first noise filtering the sensing voltage to increase a signal-to-noise ratio (SNR);
comparing the filtered sensing voltage with the initial reference voltage to output the primary change in voltage; and
correcting an offset voltage component due to temperature change from the sensed voltage change to output the change in voltage due only to touch.
